(19) United States
(12) Patent Application Publication
(10) Pub. No.: US 2024/0151387 A1
(43) Pub. Date: May 9, 2024

(54) Household appliance with light beam projection device

(71) Applicant: emz-Hanauer GmbH & Co. KGaA, Nabburg (DE)

(72) Inventors: Lukas Schade, Nabburg (DE); Martin Brabec, Nabburg (DE); Manfredi Signorino, Wackersdorf (DE)

(21) Appl. No.: 18/372,974

(22) Filed: Sep. 26, 2023

(30) Foreign Application Priority Data
Nov. 7, 2022 (DE) 102022129298.3

(51) Int. Cl. F21V 14/00; F21K 9/233; F21V 17/06

(52) U.S. Cl. CPC F21V 14/006; F21K 9/233; F21V 17/06; F21W 2131/30

(57) ABSTRACT

The invention relates to a household appliance, in particular selected from a group consisting of a dishwasher, a washing machine, and an oven, with a light beam projection device for projecting light beams onto a room floor surface located outside the household appliance, wherein the light beam projection device comprises as light source a laser light source which is arranged directly in a floor area of the household appliance facing the room floor surface in such a way that its laser light beams emit the laser light source output is directed directly onto the room floor surface.

### CROSS-REFERENCE TO RELATED APPLICATIONS

This patent application claims the benefit of and priority to German Patent Application No. 102022129298.3, filed on Nov. 7, 2022, which is herein incorporated by reference in its entirety.

### FIELD

The invention relates to a household appliance, in particular selected from a group consisting of a dishwasher, a washing machine, and an oven, with a light beam projection device for projecting light beams onto a room floor surface located outside the household appliance according to the preamble of the claim 1.

### BACKGROUND

Dishwashers, washing machines or ovens, especially in the newer generation, are often provided with a light source which serves to project a light spot onto the floor on which this appliance is located, for example to indicate that the dishwasher, oven or washing machine is currently in operation. That is, as soon as, for example, a dishwasher is started by a user and the door of the dishwasher, such as the front door, is closed, a light spot is perceived on the floor below this front door. Such light sources are usually always LEDs, which are characterized by spontaneous emission.

The disadvantage of LEDs used in this way is that only a low contrast of the light spot on the floor is achieved. This is due on the one hand to the length of the emission module and on the other hand to the low focal depth of the LED. Neither can desired patterns be imaged on the floor or room floor surface, nor can reliable light spots be perceived depending on the floor surface and the current daylight in the room.

### SUMMARY

Thus, it is the object of the invention to provide a household appliance with a light beam projection device, which enables a reliable perception of a light image on a surface not belonging to the household appliance.

This object is solved according to the features of claim 1.

Advantageously, a household appliance, in particular selected from a group consisting of a dishwasher, a washing machine and an oven with a light beam projection device for projecting light beams onto a room floor surface lying outside the household appliance, comprises as light source a laser light source which is arranged directly in a floor area of the household appliance facing the room floor surface in such a way that its light beam emitting laser light source output is directed directly onto the room floor surface. By using such a laser or such laser light sources, an excited emission takes place during the light emission instead of a spontaneous emission, whereby a correspondingly bright and sharp light image can be obtained on, for example, a room floor surface in the case of an active operating state of a dishwasher. The use of such laser light beams allows not only reliable detection of the laser beam on the floor in any daylight and also in sunlight, but also the possible generation of a certain desired light image form on the floor, such as the lettering of a company name, to which this household appliance has a reference. Due to the use of a laser light source, correspondingly sharp border areas are obtained, which can thus reflect different state statuses.

An essential point is that when using a laser light source, a stimulated or excited emission takes place instead of a spontaneous emission for the emission of the light beams. This has the consequence that with a stimulated emission not only a large coherence length but also a high amplitude stability of the emitted light beams is present. Such laser radiation is thus suitable for producing more intense light beams or a high light intensity and for achieving a corresponding sharpness in the image. Thus, for example, text fields and other patterns with arbitrarily small recesses can be obtained when using a correspondingly shaped aperture on the floor or room floor surface.

Preferably, laser diodes are used for such Laser light sources, which can be equipped with corresponding integrated optics.

In order to obtain such light patterns or images on the floor or room floor surface, at least one aperture device, preferably a pinhole aperture or an electro-optical aperture or also apertures for producing image patterns, can be arranged in the laser light beams between the laser light source output and the room floor surface. This enables a targeted selection of laser light beams to pass through the aperture or apertures in order to obtain an appropriately sharp image on the room floor surface. Such an aperture can be arranged in front of the laser light source output directly at the lower exit of the light beams within the housing or within a front door in the floor area. Ideally, such a pinhole is also already integrated in the housing or in the door of the household appliance in the floor area. Alternatively, an LCD display can be used, which can also be designed in one color.

Alternatively or additionally a defocusing objective device can be arranged between the laser light source output and the room floor surface. This can be, for example, one or more concave lenses that expand the laser beam and thus defocus it in order to obtain, for example, a larger area of the light image on the floor or room floor surface. If this image or the light image on the floor is nevertheless to be limited to finite dimensions, an aperture can additionally be arranged between the defocusing optics and the room floor surface, which allows a large portion of the light rays to pass through a correspondingly large opening, but a finite portion in relation to the cross section for imaging on the room floor surface.

Alternatively or additionally, one or more convex lenses can be arranged between the laser light source output and the room floor surface, which can be arranged at a predeterminable distance from the laser light source depending on their focus length. In addition, an aperture can be arranged between this convex lens and the room floor surface. Depending on the distance to the laser light source this convex lens is arranged, a different imaging area of a laser light spot on the room floor surface is achieved. Thus, a focusing of the laser light beams to a spot at the location of the room floor surface, a collimation to a laser light beam or a not complete focusing can be achieved.

For example, a laser light source in the form of a laser diode or laser module, a defocusing objective device and a convex lens device can be arranged one behind the other. A aperture device can also be located downstream. This makes it possible for the defocusing objective device first to expand the laser light beams and then to obtain a parallelization of the laser light beams at the location of the room floor surface by means of the convex lens device. This makes it possible to obtain a desired light image with exact marginal areas when using an aperture device and to read the text accurately when using a text-imaging aperture.

In addition, in such an arrangement the defocusing objective device as well as the convex lens device can be designed to be movable relative to each other as well as to the laser light source and a pinhole in order to obtain the previously mentioned light spot sizes on the room floor surface in the desired form.

In particular, when using a laser diode, a lens or lens device that is not symmetrical in its cross-section is preferably used in order to achieve a compensation of fast and slow laser axes, which are often present in laser diodes.

Due to the high focal depth of the laser light sources, one or more light spots generated on the room floor surface can also be actively changed in their position on the surface and generate a warning sign. This can emphasize corresponding warning messages, for example. An interrupted light beam as an image on the floor surface is also conceivable in order to be able to reproduce a kind of alarm signal. Similarly, fast and slow laser axes with different divergence angles can be used to reproduce broad lettering on the floor surface.

In this context, it is also conceivable that the laser light beams are split into several light beams, which can be done by means of appropriately designed aperture devices or by laser light beam splitting. As a result, a plurality of light beam spots can be detected on the room floor surface.

If a two- or multi-colored logo or the like from a manufacturer of the household appliance is to be displayed on the room floor surface, it is conceivable that LCD surfaces are used which are excited by the optical polarization of the laser light beams with different wavelengths and produce a multi-colored logo or similar pattern on the room floor surface. This makes the arrangement of several apertures within one aperture device unnecessary. This requires more than one laser source and different wavelengths of laser beams.

The use of a multi-color image and also the desired image of a character consisting of several colors whose colors change can be achieved, for example, by the number of lasers being more than one laser or by using a laser in combination with an LED as a further light source. Hereby, this plurality of laser light sources can be activated differently and thus a color change in the image on the room floor surface can be achieved.

Laser light sources whose wavelength can be changed to produce different colors are also conceivable.

It is also possible to arrange a fluorescent material in the form of a surface element in the optical path or on the path between the laser light source output and the room floor surface, which contributes to different fluorescence images on the room floor surface through excitation by the laser light beams.

Such a fluorescent material can be changed in its properties and color reproduction not only mechanically, but also by optical excitation energy and its change.

Additive color mixtures are also conceivable for bringing about color combinations and color changes by introducing corresponding elements into the optical path.

Preferably, an intensity device for laser light beams is also conceivable in the light path or in the optical path, which enables the intensity of the Laser light beam to be changed.

It is conceivable that line or cross lasers are used, for example, in order to be able to image desired exact line structures.

### BRIEF DESCRIPTION OF THE DRAWINGS

Further advantageous embodiments result from the sub-claims in connection with the following drawing:

It shows:

FIG. 1 in a schematic representation of a household appliance with a light beam projection device according to the subject matter of the invention;

FIG. 2 in a basic principle representation the light beam projection device for a household appliance according to a first embodiment of the invention;

FIG. 3 in a basic principle representation the light beam projection device for a household appliance according to a second embodiment of the invention;

FIG. 4 in a basic principle representation the light beam projection device for a household appliance according to a third embodiment of the invention;

FIG. 5 in a basic principle representation the light beam projection device for a household appliance according to a fourth embodiment of the invention;

FIG. 6 in a basic principle representation the light beam projection device for a household appliance according to a fifth embodiment of the invention;

FIG. 7. in a basic principle representation the light beam projection device for a household appliance according to a sixth embodiment of the invention;

FIG. 8. in a basic principle representation the light beam projection device for a household appliance according to a seventh embodiment of the invention;

FIG. 9. in a perspective view, a laser diode having un-symmetrical lens optics for use in one embodiment of the invention;

FIGS. 10a and 10b in a schematic representation examples of possible light imaging patterns.

### DETAILED DESCRIPTION

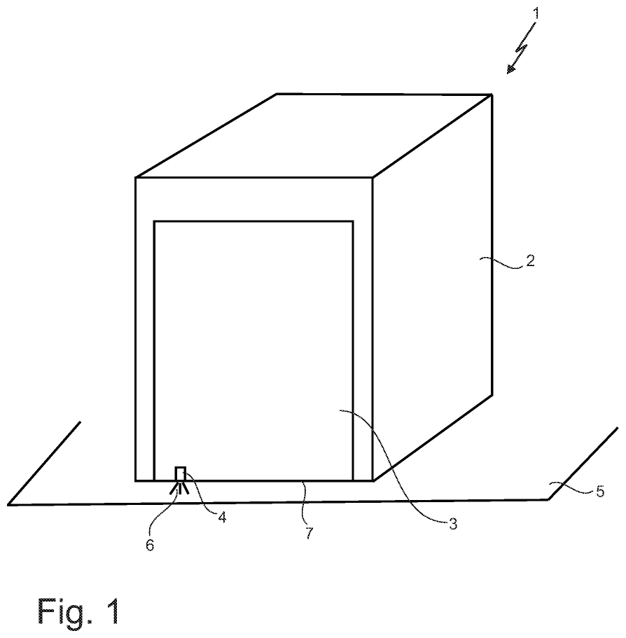

In FIG. 1, there is shown in schematic perspective view a household appliance comprising a light beam projection device according to the subject matter of the invention. Such a household appliance 1 comprises a housing 2 with a front door 3 which can be opened, for example, towards the front.

At the lower end of the front door 3, which may for example be the door of a dishwasher, the light beam projection device 4 is arranged in the lower region, i.e. in the floor region to a room floor surface 5, which is oriented in such a way that the laser light beams emerging from a laser light source output are directed directly onto the room floor surface 5. Accordingly, these laser light beams 6 are not guided through a light guide or the like to an exit opening in the floor area of the front door 3, but are directed within the light beam projection device with said laser light source directly onto a floor or room floor surface 5.

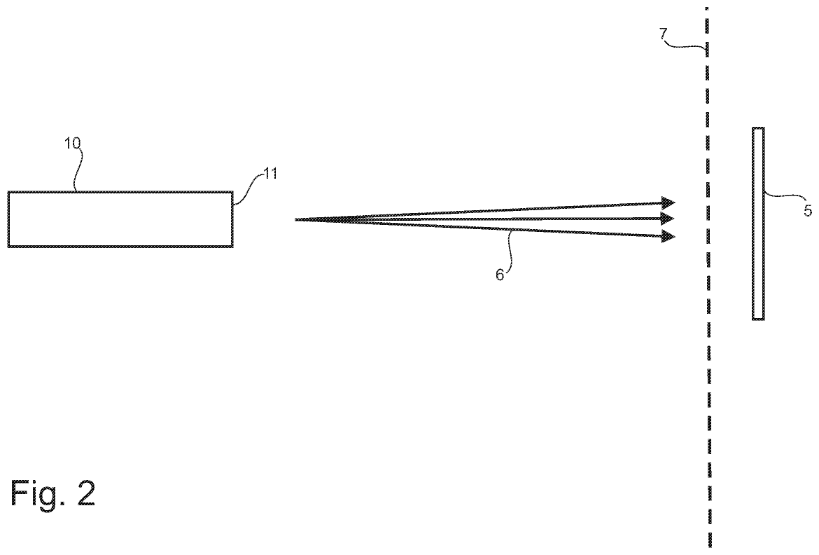

In FIG. 2, a light beam projection device for a household appliance according to a first embodiment of the invention is shown according to a functional representation. It can be seen from this representation that a laser module 10c, which can also be a laser diode, has a laser light source output 11, from which laser light beams 6 emerge. These beams strike a floor area 7 of the front door 3, which is shown here only schematically. In this floor area 7 of the front door, the laser light beams emerge from the front door 3 and thus from the entire housing of the household appliance and strike the room floor surface 5.

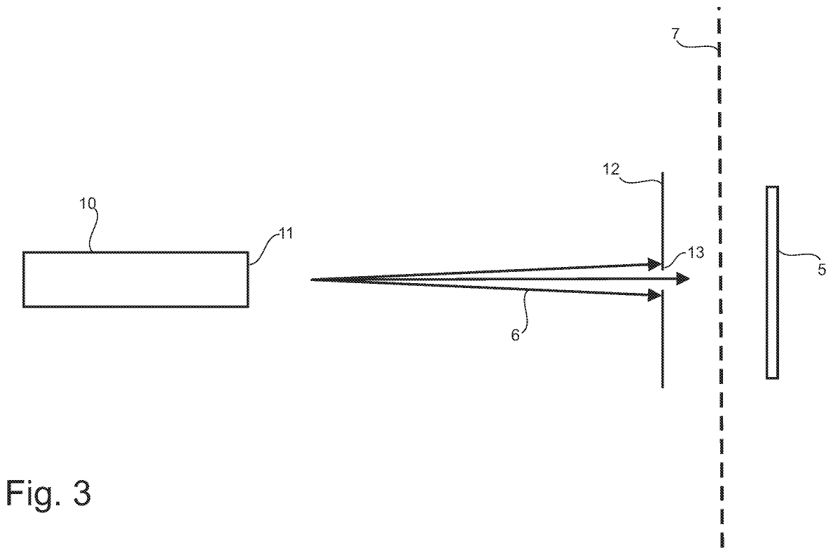

FIG. 3 shows a functional representation of a light beam projection device for a household appliance according to a second embodiment of the invention. In this representation, an aperture 12 is now arranged as a further component, which can be designed, for example, as a perforated aperture and allows only certain laser light beams to pass through a hole 13, namely those which have a course aligned as far as possible perpendicularly to the room floor surface. This results in an exact representation of a light image on the room floor surface 5, which has a desired exact edge area, for example in the form of a circle.

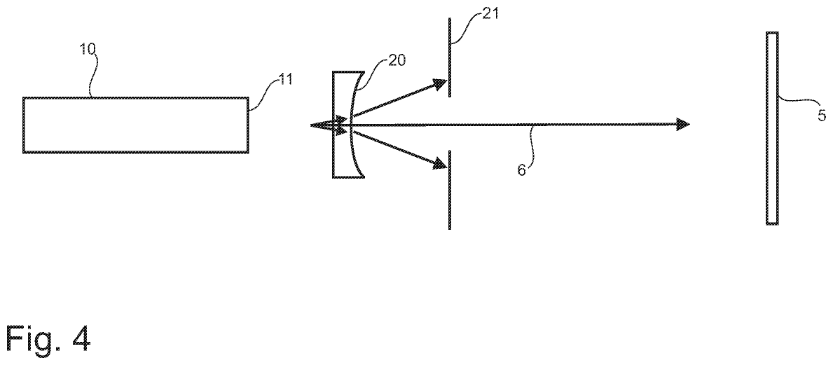

FIG. 4 shows a basic functional representation of a light beam projection device for a household appliance according to a third embodiment of the invention. In this illustration, a defocusing objective device 20 is shown, which first expands, i.e. defocuses, laser light beams 6 emerging from the laser light source output 11, in order to then selectively sort out a laser light spot in a desired cross-sectional size by means of an aperture 21 and allow it to continue to pass through in the direction of the room floor surface 5. In this way, for example, an enlarged circular light image is obtained on the room floor surface 5 with exact edge representations.

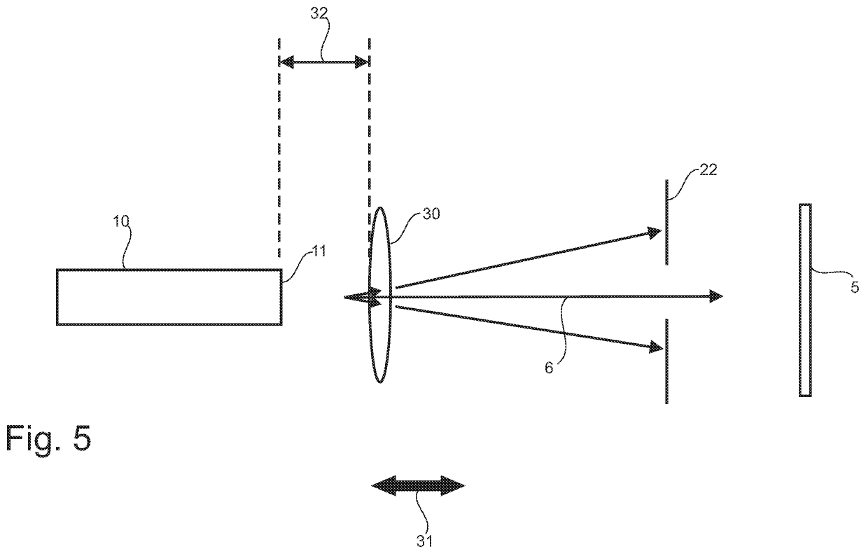

In FIG. 5, a basic functional representation of a light beam projection device for a household appliance is shown according to a fourth embodiment. In this representation, a convex lens device is arranged which, depending on its positioning between the laser light source output 11 and, if necessary, an aperture 22 or a room floor surface 5, has different effects on the light imaging to be achieved in the form of a light spot on the surface of the room floor.

It can also be seen from this illustration that according to double arrow 31 a displacement of the convex lens 30 is conceivable in order to thus produce different distances from this convex lens 30 to the laser light source output 11.

If a distance 32 is greater than a focus length of the convex lens 30, a focusing of the laser light beams to the size of a desired light spot takes place, which is subsequently imaged on the room floor surface 5 in a finite cross-sectional size.

If the distance 32 corresponds to the focus length of the convex lens 30 or the associated lenses, i.e. is identical, collimation of the laser beam or the laser light beams is achieved. This means that all laser light beams are brought onto a mutually parallel path and a correspondingly large light image is produced on the room floor surface 5. Thus, an increase in the cross-sectional area of the laser spot in the area of the room floor surface can be obtained.

If the distance 32 is smaller than the focus length of the lenses belonging to the convex lens arrangement 30, an expansion of the laser light beams and thus of the laser spot of the desired size is obtained and thus a larger cross-sectional image, for example in the form of a circle, is obtained at the location of the room floor surface 5, since no complete focusing of the laser light beams takes place.

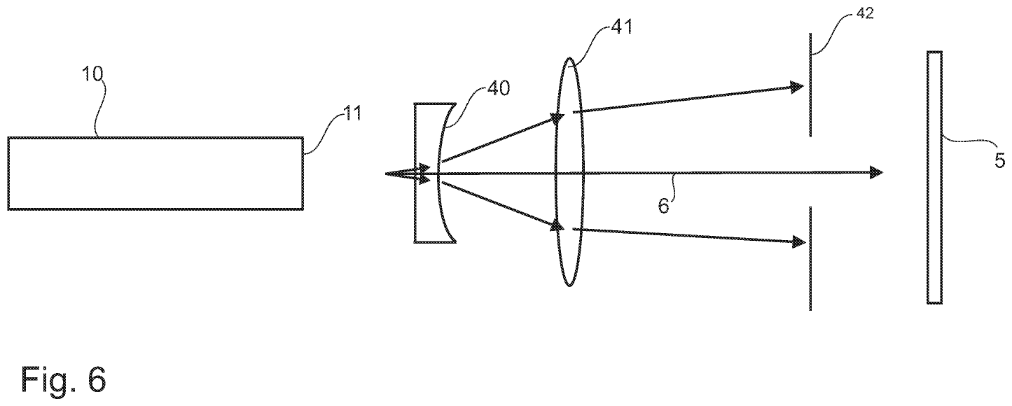

In FIG. 6, a schematic functional representation is shown of a light beam projection device for a household appliance according to a fifth embodiment of the invention. In this embodiment, a defocusing objective device 40 is arranged together with a convex lens device 41 in an optical path between laser light source output 11 and the room floor surface 5. In addition, an aperture 42 is reproduced.

By such an arrangement of objective devices, first an expansion of the laser light beams 6 and subsequently a parallelization or also a bundling of the laser light beams after exit from the convex lens device 41 can be obtained. Which of these parallelized or largely parallelized laser light beams are to pass through the aperture 42 for imaging on the room floor surface 5 with a desired cross-sectional area size is determined by the size of the opening in the aperture 42. This opening in the aperture can, of course, have a wide variety of shapes. For example, the shape of a square, a circle, or even the shape of a text, a word, a pictorial representation, a logo, etc.

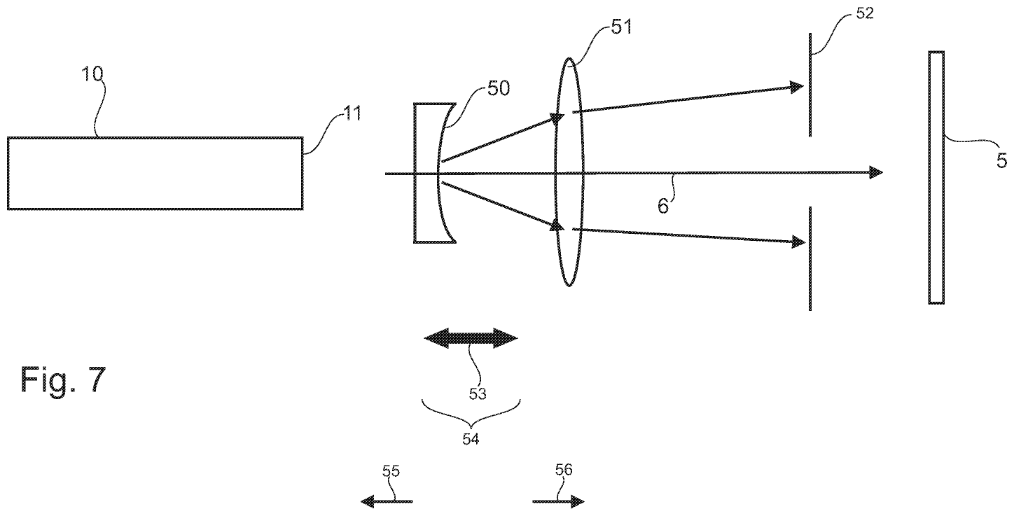

FIG. 7 shows a functional diagram of a light beam projection device for a household appliance according to a sixth embodiment of the invention. The operation of the light beam projection device according to this sixth embodiment differs from that of the light beam projection device according to the fifth embodiment in that a defocusing objective device 50 and a convex lens device 51 are movable along an optical path. This can be done by shifting the two devices 50 and 51 in relation to each other according to double arrow 53 or by shifting them together in their distance according to reference lines 54 in direction 55 of the laser light source output 11 or in direction 56 of an aperture 52. In this way, different focusing effects of the laser light beams and also a desired selection by the aperture 52 can be obtained.

In principle, any type of lens system can be used, i.e. also the systems not shown in more detail here.

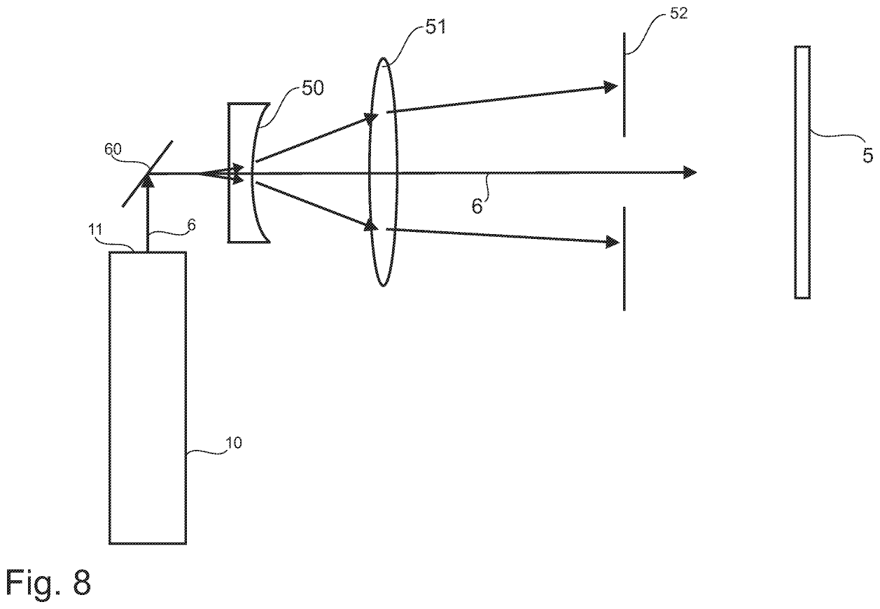

FIG. 8 shows a basic principle illustration of the light beam projection device for a home appliance according to a seventh embodiment of the invention. This embodiment differs from the embodiment shown in FIG. 7 in that the laser light source 10 with a laser light source output 11 is oriented differently than according to the sixth embodiment shown in FIG. 7. In this case, a laser light beam 6 emerging from the laser light source output 11 is deflected by a mirror 60 to subsequently strike the defocusing objective device 50 and the convex lens device 51. Any angle of alignment of the laser light source and thus of the mirror to be aligned is conceivable here.

It is also conceivable to arrange several mirrors for multiple deflection of a laser light beam.

Such a mirror 60 can in principle be arranged at any point of the beam path, for example directly at the laser light output 11 or also in the vicinity of a light output at the lower end of the household appliance, i.e. in the vicinity of the room floor surface. For this purpose, the laser module and the direction of a laser light beams, which emerges from the laser light source output, can have any conceivable angle in its orientation, as long as by means of the mirror 60 a sufficiently focusing deflection takes place in the direction of a room floor surface and, if necessary, focusing devices 50, 51, 52 set up therebetween.

Such a mirror 60 can be designed as a plane and flat mirror or also have a concave or convex shape. This mirror can advantageously be either stationary or, for example by means of a motor drive or MEMS, movable and, if necessary, pivotable in order to obtain better focusing and deflection properties. For example, when the laser light source is installed or removed, it may be necessary to refocus, which would be possible with such a mirror. However, certain desired images on the room floor surface can also be obtained by a moving mirror 60 along different shifting axes or a tilting.

The mirror may be a simple mirror or a multifaceted mirror.

The two Lens devices 50,51 are preferably fixed in their position when a mirror 60 is used. The position of these devices and their optical properties define the focusing, defocusing and spot size adjustment process.

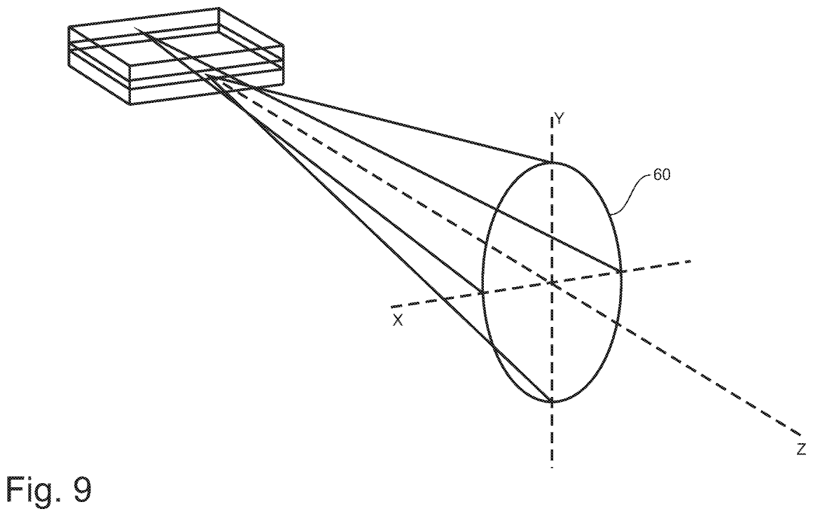

FIG. 9 shows a simple representation of a laser diode with a lens device 61, which has the object of correcting the oval-shaped laser beam of the laser light diode by a correspondingly asymmetrical shape in its X and Y axes, i.e. in the slow and fast axes.

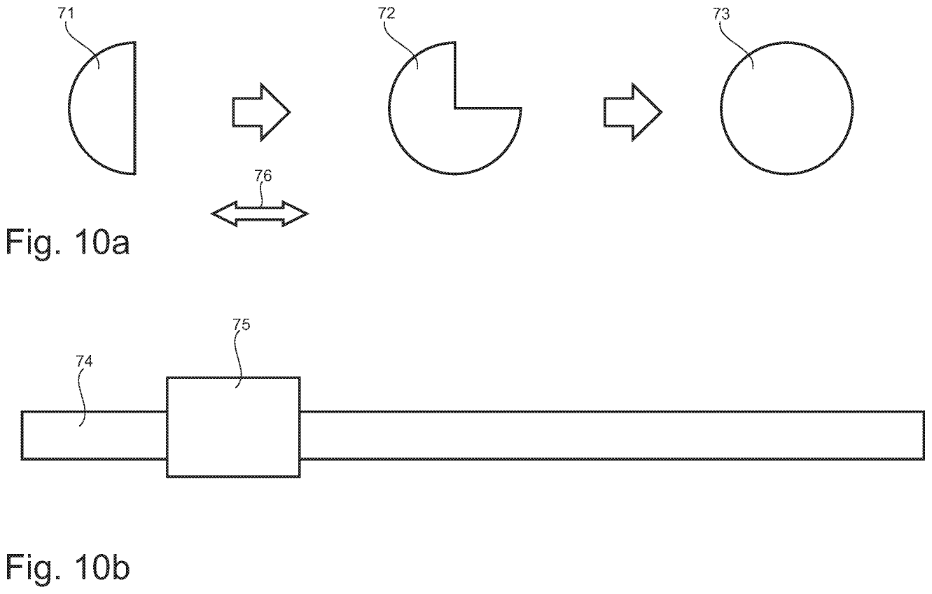

FIG. 10a shows in a schematic representation as well as FIG. 10b examples of possible light imaging patterns. In FIG. 10a, a changing light imaging pattern can be recognized with reference signs 71, 72 and 73, which has different area proportions depending on the current operating time of the device, such as a dishwasher. According to reference sign 71, for example, the dishwasher may have already run through half of its dishwashing program, whereas according to reference sign 72, three quarters of the time of the dishwashing program has already elapsed. The full circle according to reference mark 73 indicates an end of the dishwashing program. Such a changing light image as a pattern on the floor of the room is achieved, for example, by a changing aperture, which is not shown in more detail here, which opens more and more as the time increases, so that at the end a full circle according to reference sign 73 can be seen on the floor.

In FIG. 10b, a complete bar-like pattern of a light image according to reference sign 74 is shown on the ground. An aperture not shown in detail here is suitable for covering parts of this bar-like light imaging pattern 74 at different locations with increasing time, so that a gap is formed in the bar-like pattern 74 according to reference sign 75. This gap 75 is arranged on the left side at the beginning of the dishwashing program and moves slowly from left to right during the dishwashing process or its program sequence. At the end of the dishwashing process, this gap 75 is located on the far right. This is represented by the double arrow according to the reference sign 76 in its movement.

What is claimed is:

1. A household appliance selected from a group consisting of a dishwasher, a washing machine, and an oven, the household appliance having a light beam projection device configured for projecting light beams onto a room floor surface located outside of the household appliance, characterized in that the light beam projection device comprises as a light source at least one laser light source which is arranged directly in a floor region of the household appliance facing the room floor surface in such a way that a laser light source output emitting laser light beams is directed directly onto the room floor surface.

2. The household appliance according to claim 1, characterized in that an aperture device or an electro-optical aperture is arranged in the laser light beams between the laser light source output and the room floor surface, the aperture device being arranged in a at least one of a stationary, axially displaceable manner and a radially displaceable manner.

3. The household appliance according to claim 2, characterized in that the aperture device has a plurality of through-openings configured for imaging a light pattern by means of the laser light beams passing therethrough.

4. The household appliance according to claim 1, characterized in that at least one defocusing objective device is arranged between the laser light source output and the room floor surface.

5. The household appliance according to claim 1, characterized in that at least one convex lens device is arranged between the laser light source output and the room floor surface.

6. The household appliance according to claim 1, characterized in that:
at least one defocusing objective device is arranged between the laser light source output and the room floor surface;
at least one convex lens device is arranged between the laser light source output and the room floor surface; and
both the at least one defocusing objective device and the at least one convex lens device are arranged in series.

7. The household appliance according to claim 1, characterized in that:
at least one defocusing objective device is arranged between the laser light source output and the room floor surface;
at least one convex lens device is arranged between the laser light source output and the room floor surface; and
the at least one defocusing objective device and the at least one convex lens device are variable in their distance to the laser light source output.

8. The household appliance according to claim 1, characterized in that:
at least one defocusing objective device is arranged between the laser light source output and the room floor surface;
at least one convex lens device is arranged between the laser light source output and the room floor surface; and
the at least one defocusing objective device and the at least one convex lens device each comprise lenses with an asymmetrical cross-section.

9. The household appliance according to claim 1, characterized in that the laser light beams on the room floor surface can change their position by means of a diaphragm aperture displacement.

10. The household appliance according to claim 1, characterized in that the laser light beams are divided into at least two laser light beam spots starting from a common laser light source.

11. The household appliance according to claim 1, characterized in that the laser light beams are applied with at least one of different colors and intensity changes.

12. The household appliance according to claim 1, characterized in that the laser light beams are deflected between the at least one laser light source and the room floor surface by means of at least one mirror.
